(19) United States
(12) Patent Application Publication
(10) Pub. No.: US 2014/0246892 A1
(43) Pub. Date: Sep. 4, 2014

(54) ACTUATOR ARRANGEMENT FOR A SEAT AND METHOD OF ADJUSTING AN ADJUSTABLE COMPONENT

(71) Applicants: Maxime Samain, Nurnberg (DE); Stijn Coene, Vinkt (BE); Hein Claerhout, Roesbrugge (BE)

(72) Inventors: Maxime Samain, Nurnberg (DE); Stijn Coene, Vinkt (BE); Hein Claerhout, Roesbrugge (BE)

(73) Assignee: L&P SWISS HOLDING AG, Wittenbach (CH)

(21) Appl. No.: 14/348,945

(22) PCT Filed: Oct. 4, 2011
(86) PCT No.: PCT/EP2011/004940

§ 371 Date: Apr. 21, 2014

(51) Int. Cl. B60N 2/02; H02P 1/22

(52) U.S. Cl. CPC B60N 2/0228; H02P 1/22; B60N 2/0232
USPC 297/463.1; 318/446

(57) ABSTRACT

An actuator arrangement for a seat includes an adjusting linkage configured to be coupled to an adjustable component of a seat, a power drive and a switch means. The power drive has terminals and is configured to effect a relative displacement between the adjusting member (26) and the power drive. The switch means is coupled to the terminals and is configured to set a voltage applied at the terminals to a first voltage when the switch means is in a first state and to a second voltage when the switch means is in a second state different from the first state. The adjusting member and the switch means are configured such that the adjusting member causes the switch means to toggle between the first state and the second state.

### FIELD OF THE INVENTION

The invention relates to an actuator arrangement for a seat and to a method of adjusting an adjustable component of a seat.

### BACKGROUND OF THE INVENTION

Vehicle seats are relatively complex structures including a combination of subsystems that may be used to position the seat, to provide heating and cooling, or to provide an adjustable lumbar support, in addition to providing a comfortable seating area for occupants. Most importantly, vehicle seats must provide a safe and comfortable seating area. Comfortable seating is increasingly important for drivers or passengers who spend extended time periods in a motor vehicle.

Various adjustable seat components are known which add to comfort. For illustration, an adjustable lumbar support structure may be integrated into the backrest of a vehicle seat. The adjustable lumbar support structure may be configured such that an amount of curvature and/or an apical position may be adjusted. In addition, massage functions may be provided in which different zones of the lumbar structure are displaced in a cyclical manner to produce a massage effect. Such lumbar support structures frequently include a flexible member which may be formed of a wire framework and/or a plastic member, suspended on a frame of the backrest.

A change in curvature and/or apex position or a massage function may be implemented in various ways. For illustration, plural traction members may be coupled to different zones of an adjustable component to selectively apply traction thereto. An example for such a configuration is described in EP 1 762 155 A1. Other linkages may be used to effect a change in curvature and/or apex position for massage operation mode.

Traditionally, a processor or another electronic logic circuit is used to control the timing of a massage movement. The electronic logic circuit may monitor the timing of a massage program and may apply traction onto different zones of a lumbar support in a cyclical manner, in accordance with a pre-determined massage program. The electronic logic circuit may be used to also control an amplitude of massage movements and thus allows various massage operation modes to be implemented. This versatility has the drawback that the electronic logic circuit, even if implemented using a simple semiconductor chip having limited functionality, may add considerably to the costs of the seat adjusting device.

### BRIEF SUMMARY OF THE INVENTION

There is a continued need in the art for an actuator arrangement for a seat and for a method of adjusting an adjustable component of a seat which provides good comfort at moderate costs. In particular, there is a continued need in the art for an actuator arrangement and a method which allow a cyclical movement to be realized without requiring a processor.

According to an aspect, an actuator arrangement for a seat having an adjustable component is provided. The actuator arrangement comprises an adjusting linkage, a power drive, and a switch means. The adjusting linkage is configured to be coupled to the adjustable component. The power drive has terminals and is coupled to an adjusting member of the adjusting linkage. The power drive is configured to effect a relative displacement between the adjusting member and the power drive. The power drive is configured to rotate in a first direction of rotation when a first voltage is applied at the terminals and to rotate in a second direction of rotation opposite to the first direction of rotation when a second voltage is applied at the terminals. The switch means is coupled to the terminals and is configured to set a voltage applied at the terminals to the first voltage when the switch means is in a first state and to the second voltage when the switch means is in a second state different from the first state. The adjusting member and the switch means are configured such that the adjusting member causes the switch means to toggle between the first state and the second state.

In the actuator arrangement having this configuration, the adjusting member causes the switch means to toggle. The voltage supplied to the power drive is altered correspondingly, thereby causing reversal of the rotation direction of the power drive. Reversal of the rotation direction is thus effected automatically. It is not required to provide a processor.

The first voltage and second voltage may be DC voltages. The first voltage and the second voltage may have opposite polarity. I.e., when the first voltage is applied at the terminals, an electronic potential at a first terminal is greater than an electronic potential at a second terminal. When the second voltage is applied at the terminals, the electronic potential at the first terminal is smaller than the electronic potential at the second terminal. This allows the direction of rotation being cyclically altered using a DC power drive.

The adjusting member and the switch means may be configured such that the adjusting member causes the switch means to toggle from the first state to the second state when the adjusting member is in a first pre-determined position relative to the power drive, and that the adjusting member causes the switch means to toggle from the second state to the first state when the adjusting member is in a second pre-determined position different from the first pre-determined position relative to the power drive. The first and second pre-determined positions may define reversal points of a massage movement cycle.

The adjusting member may comprise a first toggle structure and a second toggle structure spaced from the first toggle structure. Thereby, a configuration may be implemented which allows the adjusting member to toggle the switch means.

The first toggle structure and the second toggle structure may be configured such that the first toggle structure interacts with the switch means when the adjusting member is in the first pre-determined position and that the second toggle structure interacts with the switch means when the adjusting member is in the second pre-determined position. Thereby, a configuration may be implemented which allows the adjusting member to toggle the switch means at pre-defined reversal points.

The first toggle structure and the second toggle structure may be configured such that the first and second toggle structures do not mechanically block a movement of the adjusting member. The first and second toggle structures may be configured so as to allow the adjusting member to be moved beyond the first pre-determined position and beyond the second pre-determined position, when a manual operation mode is activated. This allows an amplitude of a massage movement to be selected different from, in particular smaller than, the range of adjustments which is available in the manual operation mode.

The first and second toggle structures may have various configurations, depending on the implementation of the switch means. The first and second toggle structures may be formed on a surface of the adjusting member. The first and second toggle structures may be formed as geometrical features on the surface of the adjusting member. The first and second toggle structures may respectively include a feature which can be detected by a sensor of the switch means. The first and second toggle structures may respectively include an optically or electromagnetically detectable feature.

The switch means may include a displaceable element. The first toggle structure and the second toggle structure may respectively be configured for engagement with the displaceable element. Thereby, an automatic massage operation mode may be realized using a mechanical switch which is automatically toggled.

The switch means may comprise a contact-free sensor. The sensor may be configured to detect structures provided on the adjusting member. The sensor may configured to sense optical or magnetic characteristics of the adjusting member. The sensor may be configured to detect proximity of the first toggle structure and the second toggle structure. Thereby, an automatic massage operation mode may be realized without requiring a mechanical switch.

The switch means may comprise an electronically operated switch. The electronically operated switch may be a relay or similar. If the switch means has a contact-free sensor or a contact sensor for sensing proximity of the first and second toggle structure, the electronically operated switch may be coupled to the sensor.

The adjusting linkage may include at least one flexible traction member configured to couple the adjusting member to the adjustable component. The at least one flexible traction member may be at least one wire or cable of a Bowden cable. This configuration allows the power drive to be installed at a suitable location in the seat, with traction being transmitted via the at least one traction member.

The at least one flexible traction member may include a first flexible traction member and a second flexible traction member. The first flexible traction member may be coupled to a first end of the adjusting member and the second flexible traction member being may be coupled to a second end of the adjusting member opposite to the first end. Thereby, the traction applied by the first traction member and the traction applied by the second traction member may be made to change in a periodic manner. The traction of the first traction member and the traction of the second traction member may be out of phase. Thereby, a massage cycle may be implemented when the first and second traction members are coupled to different zones of an adjustable seat component, so that the different zones are activated in an alternating manner.

The adjusting member may have a structured exterior surface. The structured surface may be engaged with a transmission interconnected between the power drive and the adjusting member. Thereby, a compact design of the actuator arrangement may be attained.

The adjusting member may be supported such that it is linearly displaceable relative to the power drive. The adjusting member may be configured as a rack of a rack-and-pinion mechanism. The adjusting member may be configured as a spindle of a spindle drive. The spindle may, at one end, be attached to a seat back frame.

The actuator arrangement may include a selection switch having a plurality of states and configured to supply power to the switch means only if the selection switch is in a pre-determined state of the plurality of states. Using the selection switch, one of a massage operation mode or a manual operation mode may be selected in a user defined manner.

The actuator arrangement may include a manual operation switch electrically connected to the selection switch and to the terminals of the power drive. The selection switch may be configured to supply power to the manual operation switch only if the selection switch is in another state different from the pre-determined state. The manual operation switch may be configured to selectively apply the first voltage, the second voltage or no voltage at the terminals of the power drive, depending on whether the manual operation switch is in a first state, a second state or an idle state. The power drive may be used both for implementing the massage movement and for adjustments to the adjustable components made in response to a dedicated user selection via the manual operation switch.

According to another aspect, a seat is provided. The seat has an adjustable component and the actuator arrangement of any one aspect or embodiment. The adjusting linkage of the actuator arrangement is coupled to the adjustable component.

The adjustable component may include a first arching zone and a second arching zone mounted in a back of the seat. The first and second arching zones may be offset from each other. The adjusting linkage of the actuator arrangement may be configured to adjust a curvature of the first arching zone and a curvature of the second arching zone. Thereby, a massage cycle may be implemented by periodically adjusting curvatures of the first and second arching zones in an alternating manner.

The adjustable component may include a member mounted to be displaceable along a guide installed in a back of the seat. The adjusting linkage of the actuator arrangement may be coupled to the member and may be configured to displace the member along the guide. Thereby, a massage cycle may be implemented by displacing the member along the guide in a reciprocating manner.

The member may be coupled to a first guide and to a second guide mounted in the back the seat. The first and second guides may respectively extend along a longitudinal axis of the back.

The power drive may be mounted to the member. Thereby, a compact design may be attained. No dedicated installation space at a fixed location in the seat has to be provided for the power drive.

The adjusting member may be a spindle of a spindle drive. A sleeve in which the spindle is received may also be mounted to the member so as to be displaceable together with the member along the guide. The spindle may extend parallel to the guide.

According to another aspect, a method of adjusting an adjustable component of a seat is provided. In the method, the adjustable component is adjusted in a cyclic manner using the actuator arrangement of any one aspect or embodiment.

The actuator arrangement and method according to embodiments may be utilized for various seats having an adjustable component. For illustration, the actuator arrangement and the method may be utilized to adjust a lumbar support in a vehicle seat.

Embodiments of the invention will be described with reference to the accompanying drawings.

### BRIEF DESCRIPTION OF DRAWINGS

FIG. 1 is a perspective view of a seat structure having an actuator arrangement according to an embodiment.

FIG. 2 is a schematic view of an actuator arrangement according to an embodiment.

FIGS. 3-6 are views illustrating operation of the actuator arrangement of FIG. 2.

FIG. 7 is a schematic view of an actuator arrangement according to another embodiment.

FIG. 8 is a schematic view of a seat having an adjustable component and an actuator arrangement according to yet another embodiment.

FIG. 9 is a schematic view of a power drive and adjusting member of an actuator arrangement according to another embodiment.

FIGS. 10 and 11 are views illustrating operation of the actuator arrangement of FIG. 9.

FIG. 12 is a diagram illustrating electrical connections for switches of actuator arrangements according to embodiments.

FIG. 13 is a schematic perspective view of a switch used in an actuator arrangement according to another embodiment.

FIGS. 14-16 are views illustrating operation of the actuator arrangement having the switch of FIG. 13.

FIGS. 15 and 16 are views illustrating operation of an actuator arrangement according to another embodiment.

FIGS. 17 and 18 are views illustrating operation of an actuator arrangement according to yet another embodiment.

FIGS. 19 and 20 are views illustrating operation of an actuator arrangement according to another embodiment.

FIGS. 21 and 22 are views illustrating operation of an actuator arrangement according to another embodiment.

FIGS. 23 and 24 are views illustrating operation of an actuator arrangement according to another embodiment.

### DETAILED DESCRIPTION OF EMBODIMENTS

Exemplary embodiments of the invention will be described with reference to the drawings. While some embodiments will be described in the context of specific structural features, such as support members formed as wire pads, the embodiments are not limited to these specific structural features. The features of the various embodiments may be combined with each other unless specifically stated otherwise. Elements or features which correspond to each other with regard to their construction and/or function are designated with the same reference numerals.

Several embodiments will be described with reference to a lumbar support structure for a seat, in particular for a motor vehicle seat. In this context, terms such as “side”, “upper”, “lower”, “forward”, “rearward” or similar refer to positions or directions given in a vehicle frame of reference. I.e., a “lower” side or end is a side or end facing towards the vehicle base, an “upper” side or end is a side or end facing towards the vehicle roof, and the “lateral” direction is a direction parallel to the vehicle base and orthogonal to the vehicle longitudinal axis. A “forward” direction corresponds to an occupant's viewing direction parallel to center axis of the vehicle seat, and the “rearward” direction is opposite to the “forward” direction.

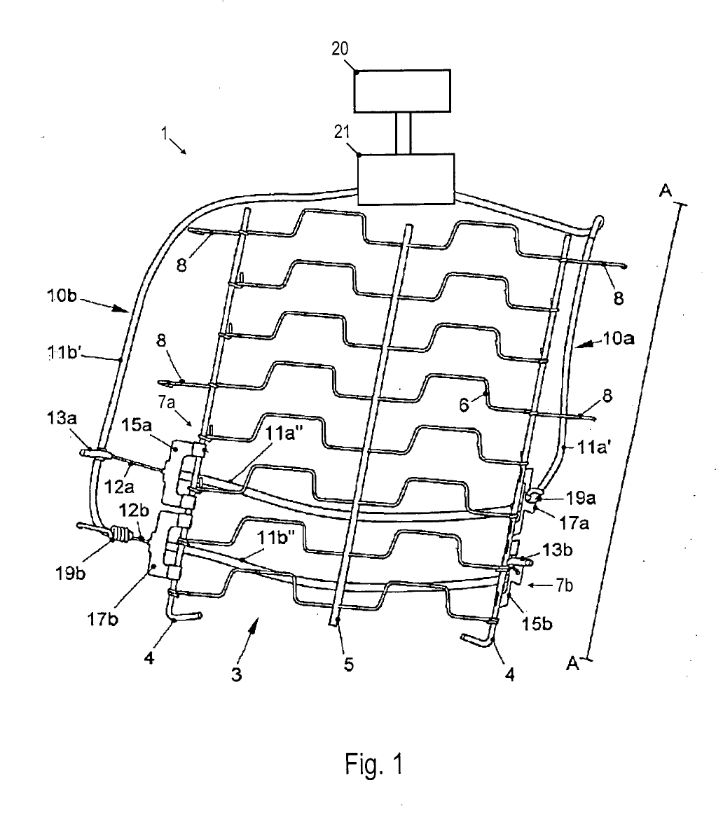

FIG. 1 shows a seat structure 1 for a vehicle seat. The seat structure 1 includes an adjustable component 3. The adjustable component 3 may be configured as a wire framework having side wires 4, a center wire 5 and transverse wires 6. For some of the transverse wires 6, ends 8 may project beyond the side wires 4. The ends 8 may be configured for engagement with side members of a seat back frame.

The adjustable component 3 may also have other configurations. For illustration, the adjustable component 3 may comprise one or several plastic belts and/or wires forming a wire framework. The adjustable component may also include a plastic basket and arching members disposed adjacent the plastic basket.

A plurality of flexible cables 10a, 10b are attached to sides 4 of the adjustable component 3 at plural positions offset along the sides 4 of the adjustable component 3. The cables 10a, 10b may be configured as Bowden cables respectively having an inner wire 12a, 12b and an outer sheath. For illustration, Bowden cables 10a and 10b are connected to the adjustable component 3 at plural locations offset along the sides 4. Bowden cable 10a is coupled to a zone 7a. Bowden cable 10b is coupled to another zone 7b which is offset from the zone 7a along the longitudinal axis A of the seat back. This allows the zones 7a, 7b to be displaced in a forward direction when traction is applied via the respective Bowden cable.

The Bowden cable 10a has an inner wire 12a. The inner wire 12a is guided to an attachment bracket 17a in an outer sheath 11a′. The inner wire 12a is guided across a rear side of the adjustable component 3 in another outer sheath 11a″. Ends of the other outer sheath 11a″ are received in receptacles in the attachment bracket 17a and in an attachment bracket 15a. An end of the inner wire 12a may be engaged with a side member of the seat back frame using an engagement member 13a, such as a hook. On the opposing side, the attachment bracket 17a may be attached to the opposing side member of the seat back frame using another hook 19a.

Similarly, the Bowden cable 10b has an inner wire 12b. The inner wire 12b is guided to an attachment bracket 17b in an outer sheath 11b′. The inner wire 12b is guided across a rear side of the adjustable component 3 in another outer sheath 11b″. Ends of the other outer sheath 11b″ are received in receptacles in the attachment bracket 17b and in an attachment bracket 15b. An end of the inner wire 12b may be engaged with a side member of the seat back frame using an engagement member 13b, such as a hook. On the opposing side, the attachment bracket 17b may be attached to the opposing side member of the seat back frame using another hook 19b.

Other adjusting linkages may be used instead of or in combination with Bowden cables. For illustration, linkages having rigid members may be used instead of flexible wires or cables.

The seat structure 1 also has an actuator 21. The actuator 21 includes a power drive installed in a housing of the actuator. An adjusting member is coupled to the power drive. The adjusting member is supported so that it is displaceable relative to the power drive. The adjusting member may be arranged in the housing of the actuator. When a first voltage is applied at power supply terminals of the power drive, the power drive causes the adjusting member to be displaced in a first direction. When a second voltage is applied at the power supply terminals of the power drive, the power drive causes the adjusting member to be displaced in a second direction which is opposite to the first direction.

A switch is also provided in the housing of the actuator 21. The switch is coupled to the power supply terminals of the power drive. The switch is configured such that one of the first voltage and the second voltage is selectively supplied to the power supply terminals of the power drive, depending on whether the switch is in a first state or in a second state. The switch interacts with the adjusting member such that the adjusting member causes the switch to toggle between the first and second state.

The adjusting member automatically effects a change in the voltage supplied to the power drive when it toggles the switch. The adjusting member thus effects a reversal of its direction of movement. A reciprocating movement of the adjusting member can thereby be attained without requiring a logic circuit for controlling the power drive.

The switch may have various configurations, as will be explained in more detail in the following. The switch may be configured as a mechanically actuable switch. The switch may be formed of, or may include, an electrically operated switch, such as a relay, or an electronically operated switch. The electrically or electronically operated switch may be coupled to a sensor. Responsive to a signal from the sensor, the switch may change the voltage supplied to the power drive between the first and second voltage.

The power drive may be a DC power drive. The first and second voltages may have equal magnitude, but opposite polarity. The power drive may be configured such that reversal of the polarity of the voltage applied at the power supply terminals causes the power drive, in particular an output shaft of the power drive, to reverse its direction of rotation.

The adjusting member may have any one of a variety of configurations, depending on the specific implementation of the adjusting linkage. The adjusting member may be a rack of a pinion-and-rack mechanism. The adjusting member may be a spindle or flexwave having a structured exterior surface, received in an internally threaded sleeve.

A power supply 20, such as a vehicle board power network or a dedicated power source, may supply power to the actuator 21.

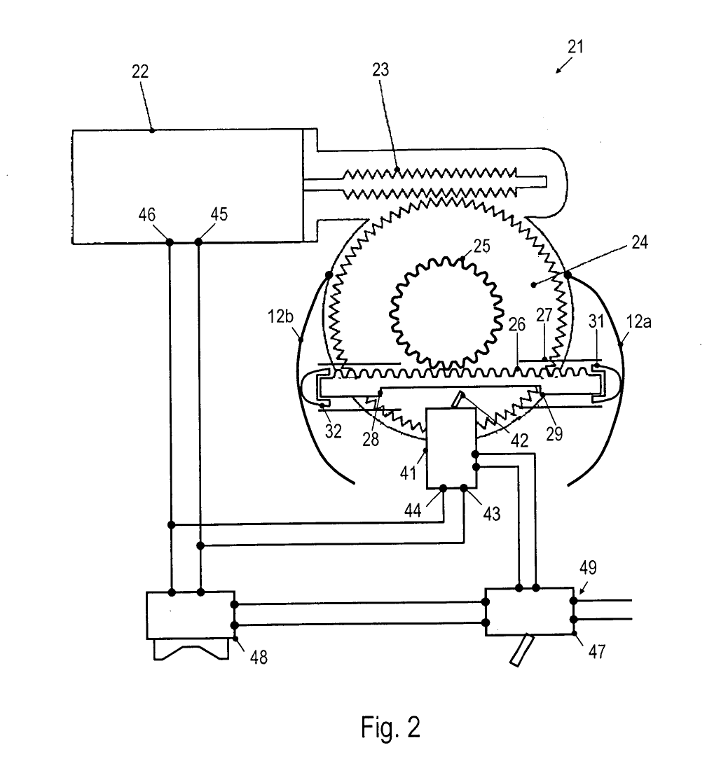

FIG. 2 shows a configuration of an actuator 21 in an actuator arrangement according to an embodiment. The actuator 21 may be used in the seat structure 1 of FIG. 1.

The actuator 21 has a power drive 22, a transmission interconnected between an output shaft of the power drive 22 and an adjusting member, and a switch 41 to automatically reverse a polarity of a voltage applied at power supply terminals 45, 46 of the power drive 21. The adjusting member may be configured as a rack 26 having a toothing. In other implementations, the adjusting member may have different configurations, such as a spindle or flexwave.

An output shaft of the power drive 22 is connected to a worm 23 in a rotationally fixed manner. The worm 23 is engaged with a worm gear 24. A pinion 25 is rotationally fixed to the worm gear 24. The pinion is engaged with the toothing of a rack 26.

The power drive 22 may be a DC power drive. When a voltage having a first polarity (referred to as “first voltage”) is applied at the power supply terminals 45, 46, the output shaft of the power drive 22 rotates in a first direction of rotation. This causes the pinion 25 to also rotate in a first direction of rotation. The rack 26 moves linearly in a first direction. A guide 27 may be provided in the actuator housing to guide linear movement of the rack 27. The first voltage may be such that an electrostatic potential at the power supply input 45 is larger than an electrostatic potential at the power supply input 46.

When a voltage having a second polarity (referred to as “second voltage”) opposite to the first polarity is applied at the power supply terminals 45, 46, the output shaft of the power drive 22 rotates in a second direction of rotation. This causes the pinion 25 to also rotate in a second direction of rotation opposite to the first direction of rotation of the pinion. The rack 26 moves linearly in a second direction which is opposite to the first direction. The second voltage may be such that an electrostatic potential at the power supply input 45 is less than an electrostatic potential at the power supply input 46. The magnitude of the second voltage may be identical to a magnitude of the first voltage.

The switch 41 has output terminals 43 and 44 electrically connected to the power supply terminals 45 and 46, respectively, of the power drive 22. The switch 41 has a first state and a second state. The switch 41 may be a mechanically actuable switch having an element 42 displaceable between a first position, corresponding to the first state of the switch 41, and a second position, corresponding to the second state of the switch 41.

When a voltage is supplied to the switch 41 via a selection switch 47 which will be described later, the first voltage is applied at the power supply terminals 45 and 46 of the power drive 22 when the switch 41 is in the first state. The second voltage is applied at the power supply terminals 45 and 46 of the power drive 22 when the switch 41 is in the second state.

The rack 26 has toggle structures at its surface which toggle the switch 41 between its first and second states. The toggle structures may be formed as steps 28, 29. The toggle structures may also be formed as protrusions or other surface features which are configured for toggling the switch 41 between its first and second state. The toggle structures may be formed such that a first toggle structure 29 causes the switch 41 to toggle from the first state to the second state when the rack 26 is in a first pre-determined position. Thereby, the polarity of the voltage at the power supply terminals 45, 46 of the power drive 41 is reversed from the first polarity to the second polarity, causing the rotation direction of the power drive and thus the linear movement of the rack 26 to be reversed. The toggle structures may also be formed such that a second toggle structure 28 causes the switch 41 to toggle from the second state to the first state when the rack 26 is in a second pre-determined position. Thereby, the polarity of the voltage at the power supply terminals 45, 46 of the power drive 41 is reversed back from the second polarity to the first polarity, causing the rotation direction of the power drive and thus the linear movement of the rack 26 to be reversed again.

The first and second toggle structures 29 and 28 may be configured such that they do not mechanically prevent the rack 26 from passing beyond the first and second pre-determined positions. This allows the rack 26 to be moved beyond the first or second pre-determined position when the actuator 21 is controlled by a specific user action. Such as specific user action may be performed in order to adjust an apex position of a lumbar support or similar. For illustration, a maximum length of travel of the rack 26 when the actuator 21 is in a massage operation mode in which the interaction of rack 26 and switch 41 gives rise to automatic reversal of the movement of the rack 26 may be less than a maximum length of travel when displacement of the rack 26 is controlled via a manual operation switch 48 which will be explained in more detail later.

When the switch 41 has mechanically moveable elements, it may be configured such that it is prevented from being toggled inadvertedly. To this end, the moveable element 42 may be biased towards the first position while the element 42 is positioned in between the first position and an intermediate position, and the moveable element 42 may be biased towards the second position while the element 42 is positioned in between the second position and an intermediate position. The element 42 may have no stable position other than the first and second positions. I.e., the switch 41 may be configured such that it does not have an idle state in which no voltage is applied at the terminals 45, 46 when the massage operation mode is selected. Alternatively or additionally, the switch 41 may be configured such that it is protected against rattling. The switch 41 may also include noise damping features to reduce noise.

The switch 41 may have any one of a variety of configurations to reverse the polarity of the voltage applied at the power supply terminals 45 and 46. For illustration, the switch 41 may be configured as a Double Pole Double Throw (DPDT) switch.

The wires 12a, 12b which are respectively connected to zones 7a, 7b of the lumbar support are coupled to the rack 26 at opposite ends thereof. A glider 31 may be provided on an end of the rack 26 so that the rack 26 may push it in one direction (to the right in FIG. 2). The wire 12a may be slideably mounted on the glider 31. An end of the wire 12a may be fixed to the housing of the actuator.

Another glider 32 may be provided on an opposite end of the rack 26 so that the rack 26 may push it in one direction (to the left in FIG. 2). The wire 12b may be slideably mounted on the glider 32. An end of the wire 12b may be fixed to the housing of the actuator.

When the rack 26 performs a reciprocating movement, with the polarity of the voltage applied at power supply terminals 45, 46 being reversed when the rack 26 toggles the switch 41, the traction applied by the wires 12a and 12b is changed in a cyclical manner. The traction applied by the wires 12a and 12b is also changed in an alternating manner, such that the traction applied by one wire increases while the traction applied by the other wire decreases, and vice versa. The resulting movement of the zones 7a and 7b of the seat structure 1 gives rise to a massage effect.

The actuator 21 may be used not only for implementing a massage movement, but also for adjusting the adjustable component of the seat in accordance with a dedicated user action. To this end, the selection switch 47 and the manual operation switch 48 may be provided. The selection switch 47 and the manual operation switch 48 may both be provided on a control panel.

The selection switch 47 allows one of a manual operation mode and a massage operation mode to be selected. In the manual operation mode, the user may control rotation of the power drive via the manual operation switch 48. In the manual operation mode, the state of the switch 41 does not affect the operation of the power drive 22. In the manual operation mode, the range of positions for the rack 26 is not delimited by the first and second pre-determined positions at which the rack 26 toggles the switch 41. In the manual operation mode, power may be supplied at the power supply terminals 45, 46 of the power drive 22 only via the manual operation switch 48.

In the massage operation mode, the operation of the power drive 22 is independent of the state of the manual operation switch 48. In the massage operation mode, power may be supplied at the power supply terminals 45, 46 of the power drive 22 only via the switch 41 which is toggled by the rack 26.

The selection switch 47 may have two positions. In one position, corresponding to the manual operation mode, voltage applied at input terminals 49 of the selection switch 47 is output only to the manual operation switch 48. In another position, corresponding to the massage operation mode, voltage applied at the input terminals 49 of the selection switch 47 is output only to the switch 41.

The manual operation switch 48 may have three states, namely an idle state, a first state and a second state. The manual operation switch 48 may be configured such that no power is supplied to the power drive 22 when manual operation mode is selected and the manual operation switch is in the idle state. The manual operation switch 48 may be configured such that the first voltage having the first polarity is applied at the power supply terminals 45, 46 of the power drive 22 when the manual operation switch 48 is in the first state. The manual operation switch 48 may be configured such that the second voltage having the second polarity opposite to the first polarity is applied at the power supply terminals 45, 46 of the power drive 22 when the manual operation switch 48 is in the second state.

By selectively setting the manual operation switch 48 to the first or second state, the rack 26 may be driven in the first or second direction, respectively. The traction applied by one of the wires 12a or 12b may be selectively increased, while the traction applied by the other one of the wires 12a or 12b may be selectively decreased. An apex position of the adjustable seat component 3 may be selectively shifted upward or downward.

The selection switch 47 and manual operation switch 48 may have various configurations. For illustration, the selection switch 47 may be a DPDT (on)-none-(on) switch. The manual operation switch 48 may be a DPDT on-on switch. The switches 47 and 48 do not need to have mechanically displaceable elements, but may also be configured using any other suitable user interface, such as a touch-sensitive control panel.

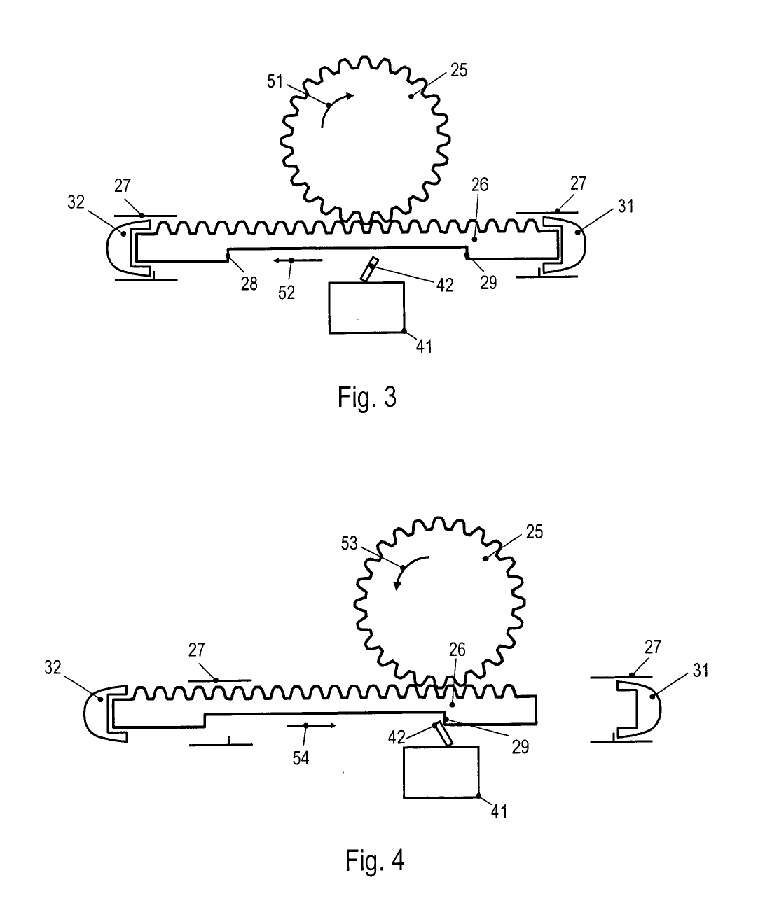

Referring to FIGS. 3-6, operation of the actuator 21 will be explained in more detail when a massage operation mode is selected. For clarity, only a partial view of the actuator 21 is shown. Other components, such as the power drive 22, worm 23 and worm gear 24 explained with reference to FIG. 2 may also be comprised by the actuator.

FIG. 3 shows a state in which the switch 41 is in a first state. A first voltage having a first polarity is applied at the power supply terminals of the power drive via the switch 41. The power drive drives the pinion 25 in a first direction of rotation 51. The rack 26 is displaced in a first linear direction 52. The rack 26 may displace the glider 32 so as to increase traction applied to the wire 12b coupled to the glider 32.

The rack 26 moves in the first direction 52 until the first toggle structure 29 interacts with the switch 41 to toggle the switch 41.

FIG. 4 shows a state in which the first toggle structure 29 interacts with the switch 41 to toggle the switch to a second state. When the switch 41 is toggled from the first state to the second state, a second voltage having a second polarity is applied at the power supply terminals of the power drive via the switch 41. The power drive drives the pinion 25 in a second direction of rotation 53. The rack 26 is displaced in a second linear direction 54 opposite to the first direction 52. The traction of the wire 12b maintains the glider 32 in abutment on the rack 26 until the glider 32 abuts on a step in the guide 27.

The direction of movement of the rack 26 is reversed when the rack 26 is in the first pre-determined position shown in FIG. 4, when the massage operation mode is actuated. The step-like toggle feature 29 may be configured such that it does not mechanically block further movement of the rack 26 in the first direction 52. This allows the rack to be driven further in the first direction 52 even when the switch 41 has toggled from the first state to the second state, when the manual operation mode is activated.

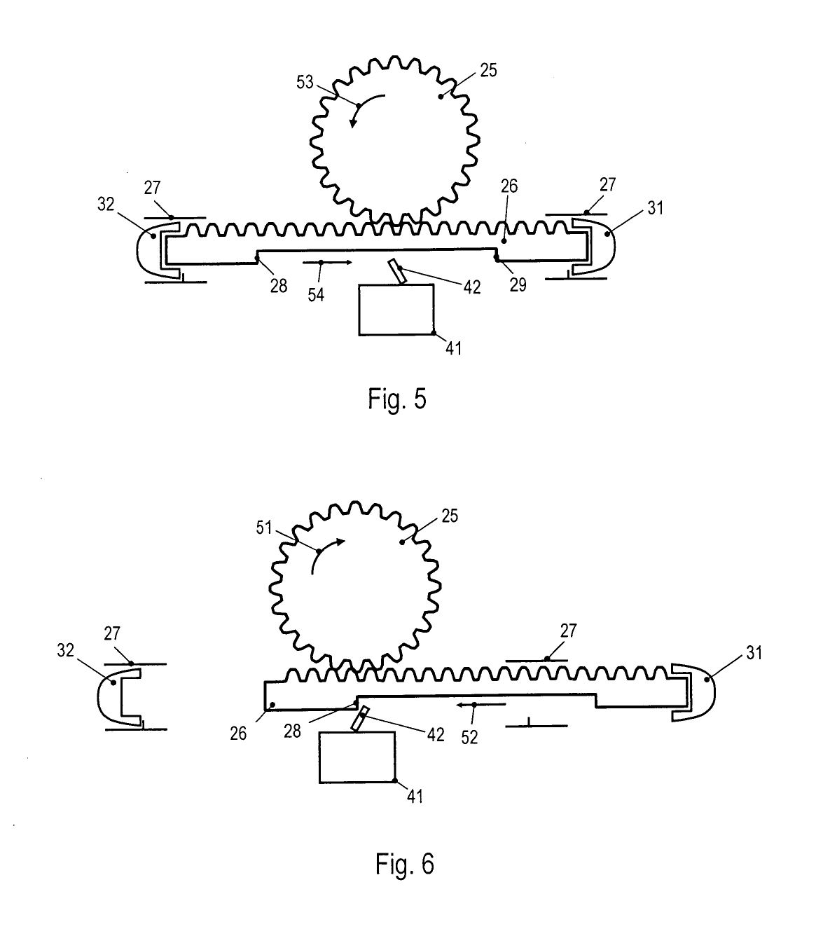

FIG. 5 shows a state in which the rack 26 has reached a neutral position again. The rack 26 continues to move in the second direction 54 until the second toggle structure 28 interacts with the switch 41 to toggle the switch 41. In this process, the rack 26 may displace the glider 31 so as to increase traction applied to the wire 12a coupled to the glider 31.

FIG. 6 shows a state in which the second toggle structure 28 interacts with the switch 41 to toggle the switch 41 back to the first state. When the switch 41 is toggled from the second state to the first state, the first voltage having the first polarity is applied at the power supply terminals of the power drive via the switch 41. The power drive drives the pinion 25 in the first direction of rotation 51. The rack 26 is displaced in the first linear direction 52 opposite to the second direction 54. The traction of the wire 12a maintains the glider 31 in abutment with the rack 26 until the glider 31 abuts on a step in the guide 27.

The direction of movement of the rack 26 is reversed when the rack 26 is in the second pre-determined position shown in FIG. 6, when the massage operation mode is activated. The step-like toggle feature 28 may be configured such that it does not mechanically block further movement of the rack 26 in the second direction 54. This allows the rack 26 to be driven further in the second direction 54 even when the switch 41 has toggled from the second state to the first state, when the manual operation mode is activated.

The switch means and adjusting member having toggle structures for toggling the switch means may have various different configurations. For illustration, a non-contact toggling of the switch means may be implemented. To this end, the switch means may be include a sensor and an electrically actuable switch, such as a relay or transistor, coupled to the sensor. The sensor may be configured to sense proximity of toggle structures provided on the adjusting member.

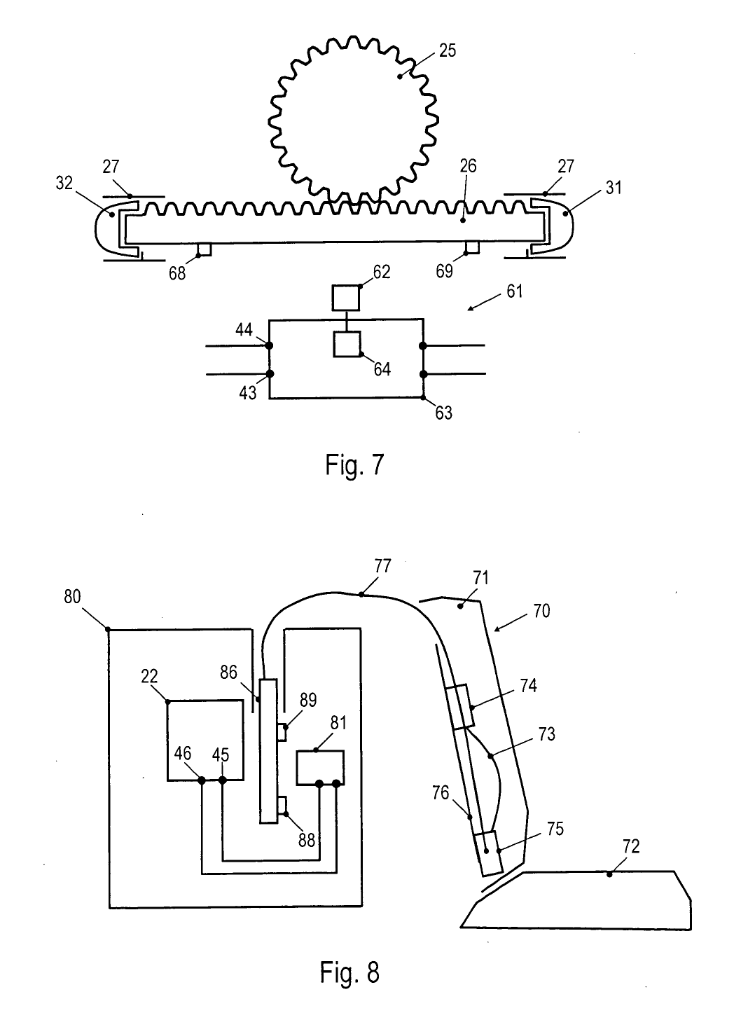

FIG. 7 shows components of an actuator arrangement having a switch means 61 using a sensor 62 and an electrically actuated switch 64. Components which correspond, in terms of function and/or constructions, to components of the actuator arrangement explained with reference to FIGS. 2-6 are designated by the same reference numerals.

The actuator arrangement also includes a power drive and transmission (not shown in FIG. 7), which may be configured as explained with reference to FIG. 2. Output terminals 43, 44 of the switch means 61 are electrically connected to the power supply terminals 45, 46 of the power drive 22. The actuator arrangement may also include a selection switch and a manual operation switch configured and operative as explained with reference to FIG. 2.

The adjusting member driven by the power drive may be configured as a rack 26. The rack 26 may be coupled to zones 7a, 7b of the adjustable component of the seat via flexible elements, such as wires or cables.

Toggle structures 68 and 69 are provided on the adjusting member 26 at positions spaced from each other along a longitudinal axis of the adjusting member 26. The sensor 62 may be configured such that it outputs a signal when one of the toggle structures 68 or 69 is positioned in proximity to the sensor 62.

The toggle structures 68 and 69 may be optically detectable features. The sensor 62 may then be configured as an optical sensor. The toggle structures 68 and 69 may be magnetic structures. The sensor 62 may then be configured as electromagnetic sensor detecting proximity of the magnetic structures.

A switch circuit 63 may include the electrically actuated switch 64. The switch circuit 63 may be configured as a DPDT on-on switch, with the switching being effected by actuations of a relay or other electrically actuated switch. Other configurations may be used for the switch circuit 63.

The operation of the actuator arrangement having the switch means 61 and adjusting member 26 of FIG. 7 corresponds to the operation explained with reference to FIGS. 2-6. The switch means 61 is toggled when one of the toggle structures 68 or 69 is positioned in proximity to the sensor 62. The polarity of the voltage applied at the power supply terminals of the power drive is reversed when the rack 26 is in a first pre-determined position in which the first toggle structure 69 is located at the sensor 62 and when the rack 26 is in a second pre-determined position in which the second toggle structure 68 is located at the sensor 62.

In another embodiment, the sensor 62 may be a contact sensor. The toggle structures 68 and 69 may be geometric features arranged to contact the contact sensor 62. The contact sensor 62 may output a signal to the switch circuit 63 when it detects contact with one of the toggle structures 68 and 69.

An actuator arrangement of an aspect or embodiment may be used to adjust adjustable seat components having various configurations. For illustration, rather than displacing zones of an adjustable seat component in a forward-backward direction, as is the case for zones 7a and 7b in the seat structure 1 of FIG. 1, an adjustable component may be linearly displaced along a guide installed in the seat under action of the actuator arrangement.

FIG. 8 illustrates a seat 70 having an adjustable component which is cyclically adjusted using an actuator arrangement of an embodiment. Components and features which have a configuration and/or operation which corresponds to components and features of one of FIGS. 1-7 are designated by the same reference numerals.

The seat 70 has a back 71 and a seat section 72. An adjustable component is installed in the back 71. The adjustable component may include a basket formed of plastic material (not shown). An arching member 73 or plural arching members may be coupled to the basket. Ends of the arching member(s) 73 are received in members 74 and 75. The members 74 and 75 may respectively be displaceable supported on a guide 76. The guide 76 may extend along a longitudinal axis of the back 71. The guide 76 may include a pair of guide rails provided on lateral sides of the back 71.

An actuator 80, which is shown schematically in FIG. 8, is coupled to the adjustable component. The actuator 80 has a power drive 22. An adjusting member 86 is supported so as to be linearly displaceable. A switch means 81 is coupled to power supply terminals 45, 47 of the power drive 22. The switch means 81 is toggled between first and second states when toggle structures 88 and 89 provided on the adjusting member 86 interact with the switch means 81. The toggle structures 88 and 89 may be geometrical features contacting the switch means 81 or a component thereof. The toggle structures 88 and 89 may also be optically or electromagnetically detectable features. The switch means and toggle structures may be configured as described with reference to FIGS. 2-6 or as described with reference to FIG. 8.

The adjusting member 86 is connected to one of the members 74 and 75 via a flexible element 77, such as a wire or cable. When the power drive 22 displaces the adjusting member 86 in one direction (downward in FIG. 8), the arching member 73 and the members 74 and 75 on which it is supported is correspondingly displaced in the back 71 of the seat 70 under the traction applied thereto by the flexible element 77. A bias spring (not shown) may be provided to bias the member 75 in one direction, e.g., in the downward direction in FIG. 8. This allows the arching member 73 and the members 74 and 75 on which it is supported to return to a rest position when the power drive 22 displaces the adjusting member 86 in the upward direction in FIG. 8.

In operation, the adjusting member 86 toggles the switch 81. The polarity of the voltage applied at the power supply terminals 45 and 46 of the power drive is reversed when the switch 81 toggles, thereby reversing the movement of the adjusting member 86. An automatic massage movement may thus be attained.

The seat 70 may have a selection switch electrically coupled to the switch 81 for selecting one of a manual operation mode or a massage operation mode. The seat 70 may also have a manual operation switch electrically coupled to the selection switch and to the power supply terminals 45, 46 of the power drive 22. The operation and configuration of the selection switch and manual operation switch may be as described with reference to FIG. 2.

The drive mechanism used for adjusting the adjustable components of the seat may have any one of a variety of configurations. For illustration, a spindle drive may be used instead of a rack and pinion mechanism. Similarly, various kinds of transmissions may be used.

While the adjusting member is displaced relative to the seat back frame in the actuator arrangements of FIGS. 1-8, the power drive may be displaced relative to the adjusting member to adjust the adjustable seat component in other embodiments. For illustration, the power drive may be installed in a member which is displaceably supported on guide rails. The power drive may be connected to a spindle of a spindle drive via a transmission. Actuation of the power drive causes the power drive and the member in which it is installed to be displaced along the guide rails. The spindle may be affixed to a structural member of the seat back.

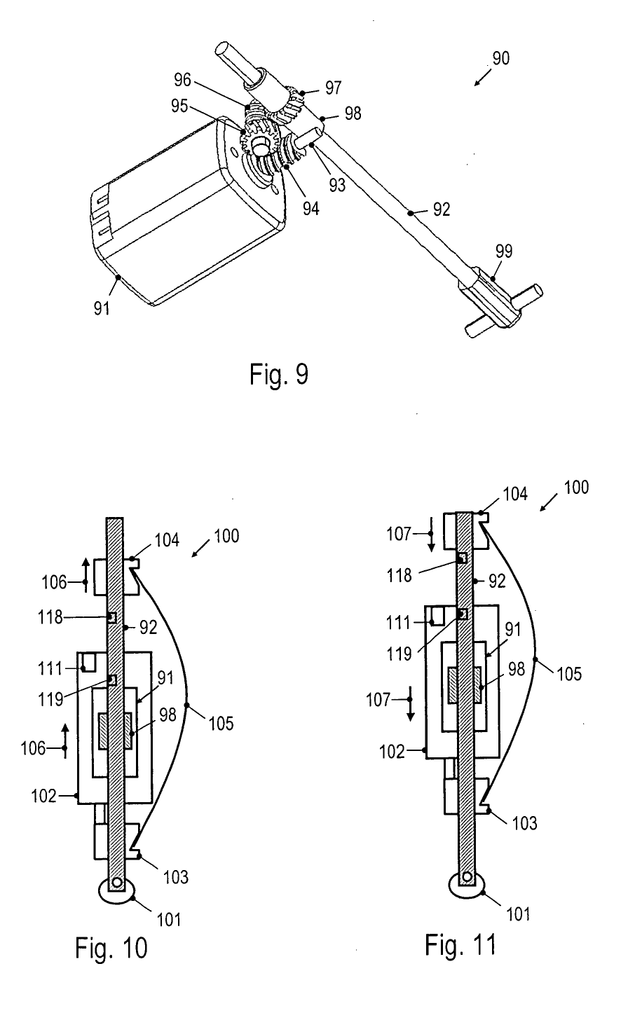

FIG. 9 shows a combination 90 of power drive, transmission and adjusting member of an actuator arrangement according to another embodiment. The power drive 91 may be installed in a member which is moveably arranged in a seat back. The power drive 91 is coupled to a spindle 92 which may be affixed to a structural member of the seat back via an engagement structure 99. A transmission may include a first worm 94 formed on an output shaft 93 of the power drive. A first worm gear 95 may be engaged with the first worm 94. A second worm 96 may be rotationally fixed to the first worm gear 95. A second worm gear 97 may be engaged with the second worm 96.

The second worm gear 97 may be formed on an exterior surface of a sleeve 98. The sleeve 98 has an internal thread engaged with an external thread of the spindle 92.

The power drive 91 may be a DC power drive. When the power drive 91 is supplied with a first voltage having a first polarity, the sleeve 98 rotates in a first direction of rotation. This causes the motor 91, the transmission and the member in which the motor 91 is supported to be displaced along the spindle 92 in a first direction.

Toggle structures which are configured to interact with a switch means to toggle the switch means may be formed on the spindle 92 or at other locations in the seat back. The switch means may be coupled to power supply terminals of the power drive 91 such that a polarity of the voltage applied at the power supply terminals is reversed between the first voltage and the second voltage when the switch means is toggled.

FIGS. 10 and 11 are schematic side views of a seat structure 100 having an actuator arrangement according to an embodiment. The actuator arrangement uses a drive mechanism configured as explained with reference to FIG. 9.

The seat structure 100 includes members 103 and 104 which are displaceably supported on a pair of guide rails (not shown) installed in a back of a seat. Ends of one or several arching members 105 are secured on both member 103 and member 104. The members 103 and 104 may be displaceable relative to each other using another drive mechanism (not shown) to adjust the curvature of the arching member(s) 105. The arching member(s) 105 may be coupled to a plastic basket. When the other drive mechanism is not actuated, the distance between the members 103 and 104 remains constant.

The power drive 91 is supported on a support member 102. The support member 102 is integrally formed with or fixedly attached to the member 103. The support member 102 and member 103 jointly move along the guide rails in the seat back.

The power drive is coupled to the sleeve 98 via a transmission (not shown in FIGS. 10 and 11). An internal thread of the sleeve 98 is engaged with an external thread of the spindle 92. The spindle 92 is affixed to a structural member 101 of the seat back.

Toggle structures 118 and 119 are formed on the spindle 92. The toggle structures may be geometrical features or other features configured to interact with a switch means 111. The switch means 111 may include a switch having a mechanically moveable element or may include a sensor and electronically actuable switch connected thereto.

The switch means 111 is coupled to power supply terminals of the power drive 91. The switch means 111 sets a voltage applied at the power supply terminals of the power drive 91 to a first voltage having a first polarity when a massage operation mode is activated and the switch means is in a first state. The switch means 112 sets a voltage applied at the power supply terminals of the power drive 91 to a second polarity opposite to the first polarity to the power supply terminals when a massage operation mode is activated and the switch means is in a second state. The switch means is toggled between the first and second states when either one of the toggle structures 118 and 119 is positioned at the switch means 111.

FIG. 10 illustrates operation of the actuator arrangement when the switch means 111 is in the first state. The first voltage having the first polarity is applied at the power supply terminals of the power drive 91. The rotation of the sleeve 98 causes the sleeve 98 and the power drive 91 to be displaced along the spindle 92. The support member 102, the member 103, the arching member 105 and the member 104 are accordingly displaced along the guide rails in a first direction 106.

FIG. 11 illustrates operation of the actuator arrangement when the toggle structure 119 has toggled the switch means 111 from the first state to the second state. The switch means 111 controls the voltage applied at the power supply terminals of the power drive 91 such that the second voltage having the second polarity is applied at the power supply terminals. The reversal in voltage polarity causes the direction of rotation of the sleeve 98 to be reversed when the switch means 111 is toggled by interaction with the spindle 92.

The rotation of the sleeve 98 causes the sleeve 98 and the power drive 91 to be displaced along the spindle 92 in a direction opposite to the one shown in FIG. 10. The support member 102, the member 103, the arching member 105 and the member 104 are accordingly displaced along the guide rails in a second direction 107 opposite the first direction 106.

The spindle 92 may be configured to flex when a load is applied in a direction normal to the longitudinal axis of the spindle 92. The attachment of the spindle 92 to the seat back structural member 101 may be such that the spindle 92 may rotate about the attachment, the rotation axis extending in the lateral direction of the seat back. Similarly, the power drive 91, two-stage worm transmission and sleeve 98 may be mounted in the member 102 so as to be pivotable about an axis normal to the longitudinal axis of the spindle 92. The drive mechanism may thus be maintained in an operable state even when the spindle 92 is displaced in a direction normal to the seat surface when a load applied to the seat surface.

For each one of the actuator arrangements described above, a selection switch for selecting one of a manual operation mode or a massage operation mode as well as a manual operation switch may be provided.

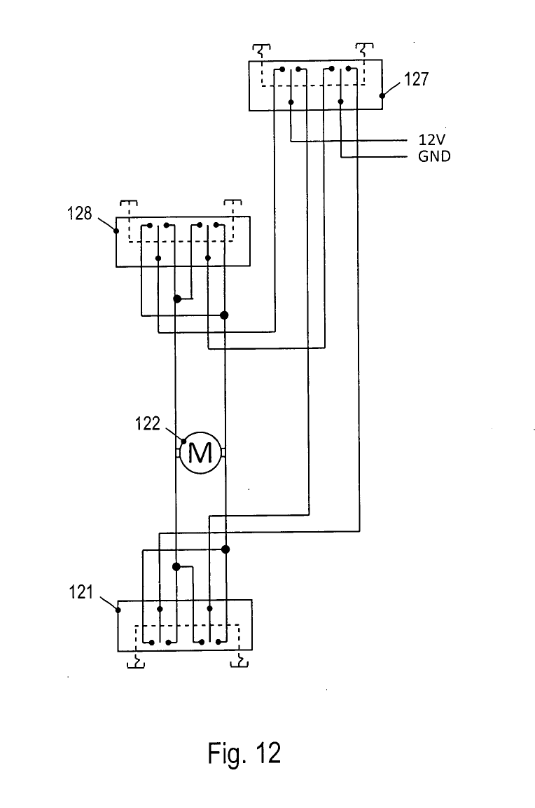

FIG. 12 is a schematic view showing the switches and wiring between the switches. A wiring as explained with reference to FIG. 12 may be used in the actuator arrangement of any embodiment.

An external supply voltage is supplied to a selection switch 127. The selection switch 127 may be configured as a DPDT on-on switch. The selection switch may be configured for manual actuation by a user. The selection switch has two states corresponding to manual operation mode and massage operation mode. In the state corresponding to the manual operation mode, the voltage at the inputs of the selection switch 127 is applied to inputs of a manual operation switch 128. In the state corresponding to the massage operation mode, the voltage at the inputs of the selection switch 127 is applied at inputs of a massage switch 121.

The manual operation switch 128 is electrically connected to the power drive 122. The manual operation switch 128 may be a DPDT switch in an on-none-on configuration. I.e., when the manual operation switch is in an idle position, no voltage is applied at the power drive 122 even if the manual operation mode is selected. If the manual operation switch is in a first state, the supply voltage is applied at power supply terminals of the power drive 122 with a first polarity. If the manual operation switch is in a second state, the supply voltage is applied at power supply terminals of the power drive 122 with a second polarity which is opposite to the first polarity. If the manual operation mode is selected, the voltage applied at the power supply terminals of the power drive 122 is independent on the state of the massage switch 121.

The massage switch 121 is electrically connected to the power drive 122. The massage switch 121 may be a DPDT switch in an on-on configuration. I.e., the massage switch 121 cannot remain in an idle position. When the massage switch 121 is in a first state, the supply voltage is applied at power supply terminals of the power drive 122 with a first polarity if the massage operation mode is selected. When the massage switch 121 is in a second state, the supply voltage is applied at power supply terminals of the power drive 122 with a second polarity which is opposite to the first polarity if the massage operation mode is selected. If the massage operation mode is selected, the voltage applied at the power supply terminals of the power drive 122 is independent on the state of the manual operation switch 128.

The massage switch 121 is toggled by an adjusting member, which is displaced under the action of the power drive 122.

Other switches and circuit components may be used. For illustration, in still other embodiments, a DPDT relay may be used in combination with a single pole single throw (SPST) switch or plural SPST switches. The SPST switch or switches may trigger the relay to switch between first and second states, thereby reversing polarity of the bias applied at the power supply terminals of the power drive. In still other embodiments, an H-bridge may be used in combination with a single pole double throw (SPDT) switch, a SPST switch, plural SPDT switches or plural SPST switches to reverse the bias applied at power supply terminals of the power drive in a periodic manner.

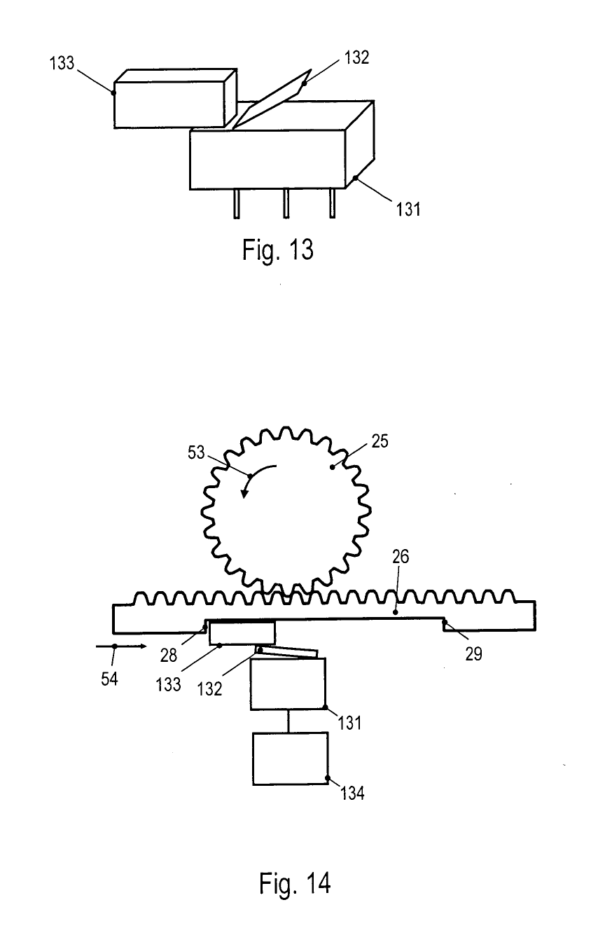

Referring to FIGS. 13-16, an actuator arrangement will be described in which a SPST switch is used to effect toggling of a DPDT relay or of an H-bridge. Components which correspond to components explained with reference to one of FIGS. 1-12 are designated with the same reference numerals. While not shown in FIGS. 14-16, the actuator arrangement also includes a power drive to which the relay or H-bridge is electrically coupled to set a voltage applied at the power supply terminals of the power drive.

FIG. 13 shows an example for a SPST switch 131. The SPST switch 131 has a moveable member 132 biased in an outward direction. Depending on the position of the moveable member 132 relative to the housing of the switch 131, the switch 131 is in a first state (e.g. “off”) or in a second state (e.g. “on”).

A intermediate member 133 is coupled to the rack 26 of the actuator arrangement. The intermediate member 133 is moveable relative to the SPST switch 131, in order to toggle the SPST switch 131. Toggling of the SPST switch 131 between on and off states is effected by the rack 26 when the rack 26 is in one of the reversal points for the massage movement.

FIGS. 14-16 illustrate components of the actuator arrangement during different stages of an operation cycle. The actuator arrangement may include any one of the other components explained with reference to FIGS. 1-12.

A relay 134, which may be a DPDT relay, or an H-bridge 134 are coupled to the SPST switch 131. Toggling of the SPST switch causes the relay 134 or H-bridge 134 to toggle, thereby reversing the polarity of the bias applied at the power supply terminals of the power drive. This in turn reverses movement of the rack 26.

FIG. 14 shows a state of the operation cycle in which the relay or H-bridge 134 is in a second state. The voltage applied at the power supply terminals of the power drive has a second polarity. The pinion 25 rotates in a second direction of rotation 53. The rack 26 is linearly displaced in a second movement direction 54.

In the state shown in FIG. 14, the intermediate member 133 forces the moveable member 132 of the SPST switch against the housing of the switch 131.

When the step 28 of the rack abuts on the intermediate member 133, the step 28 pushes the intermediate member 133 in the second direction of movement 54. The intermediate member 133 slides along the moveable member 132 and releases it once it has been pushed past the moveable member 132.

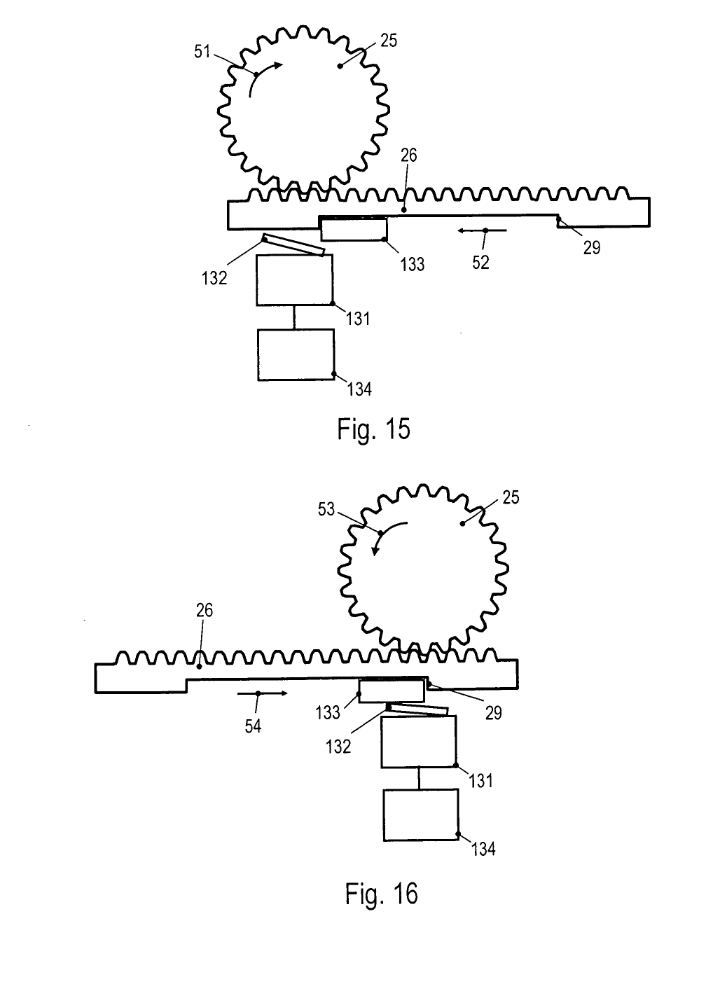

FIG. 15 shows a state of the operation cycle in which the rack 26 has moved the intermediate member 133 past the SPST switch 131. The SPST switch toggles. This in turn causes the DPDT relay or H-bridge 134 to toggle. The polarity of the bias applied at the power supply terminals of the power drive is reversed. The pinion 25 rotates in a first direction of rotation 51. The rack 26 is displaced in a first direction of movement 52.

When the step 29 of the rack engages the intermediate member 133, it forces the intermediate member to move together with the rack 26. The intermediate member 133 is thus pushed over the moveable member 133 again.

FIG. 16 shows a state of the operation cycle in which the intermediate member 133 has pressed the moveable member 132 against the housing of the switch 131. The switch 131 is toggled by the action of the rack 26. Toggling of the switch 131 causes the DPDT relay or H-bridge 134 to be toggled. The polarity of the bias at the power supply terminals of the power drive is reversed, reversing the rotation direction of pinion 25 and the movement direction of pinion 26.

The switch 131 and member 133 do not mechanically block movement of the rack 26 beyond reversal points of the massage movement. This allows the rack 26 to be driven beyond the massage mode reversal points when the manual mode is activated.

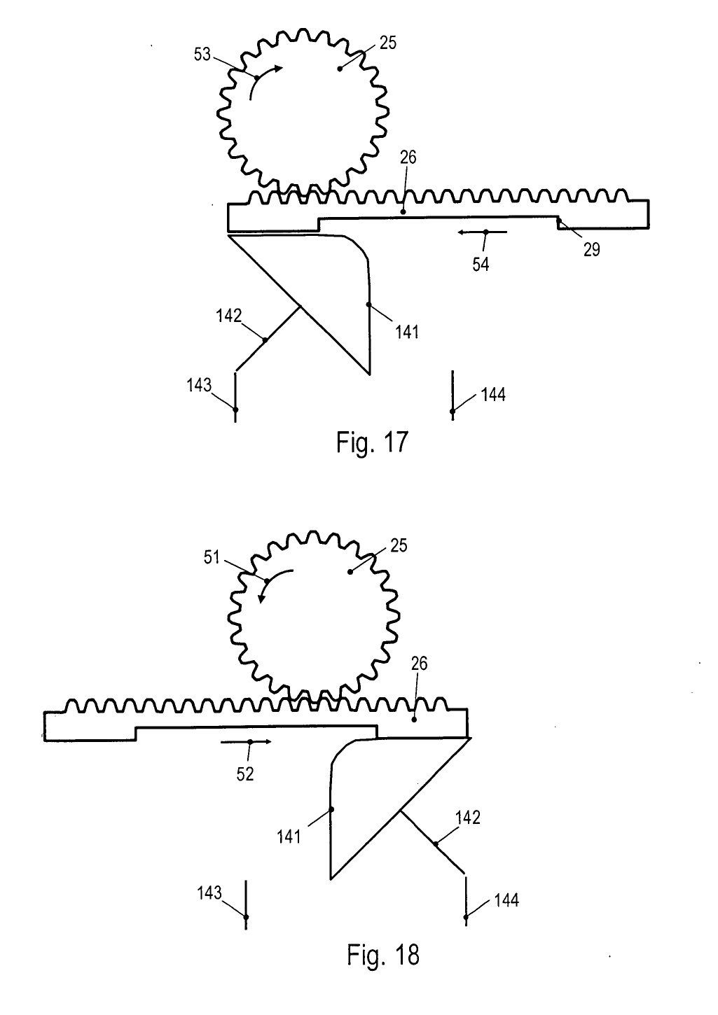

FIGS. 17 and 18 illustrate components of an actuator arrangement according to yet another embodiment during different stages of an operation cycle. Components which correspond to components explained with reference to one of FIGS. 1-12 are designated with the same reference numerals. The actuator arrangement may include any one of the other components explained with reference to FIGS. 1-12, in particular a power drive to drive the pinion 25.

The actuator arrangement uses a single pole double throw (SPDT) switch 141 having two stable positions shown in FIGS. 17 and 18, respectively. A conductive member 142 which is moveable between different positions is selectively coupled with one of conductors 143 and 144, depending on the state of the SPDT switch. A given voltage, such as 12 V relative to ground, may be supplied to conductive member 142.

When the SPDT switch 141 is toggled, a change in the potential at conductors 143 and 144 may be sensed. This change in potential may be used as a signal which changes a polarity of an H-bridge. The switch 141 may be coupled to the H-bridge such that the polarity of the H-bridge is changed in response to such a change in potential at conductors 143 and 144. The polarity of the bias applied at the power supply terminals of the power drive is thus reversed.

As illustrated in FIGS. 17 and 18, the rack 26 causes the switch 141 to toggle when the rack 26 is at the reversal points of the massage movement. The switch 141 does not mechanically block movement of the rack 26 beyond these points. This allows the rack 26 to be driven beyond the massage mode reversal points when the manual mode is activated.

In still other embodiments, plural switches or plural sensors may be used to change the polarity of an H-bridge under the action of the actuating member.

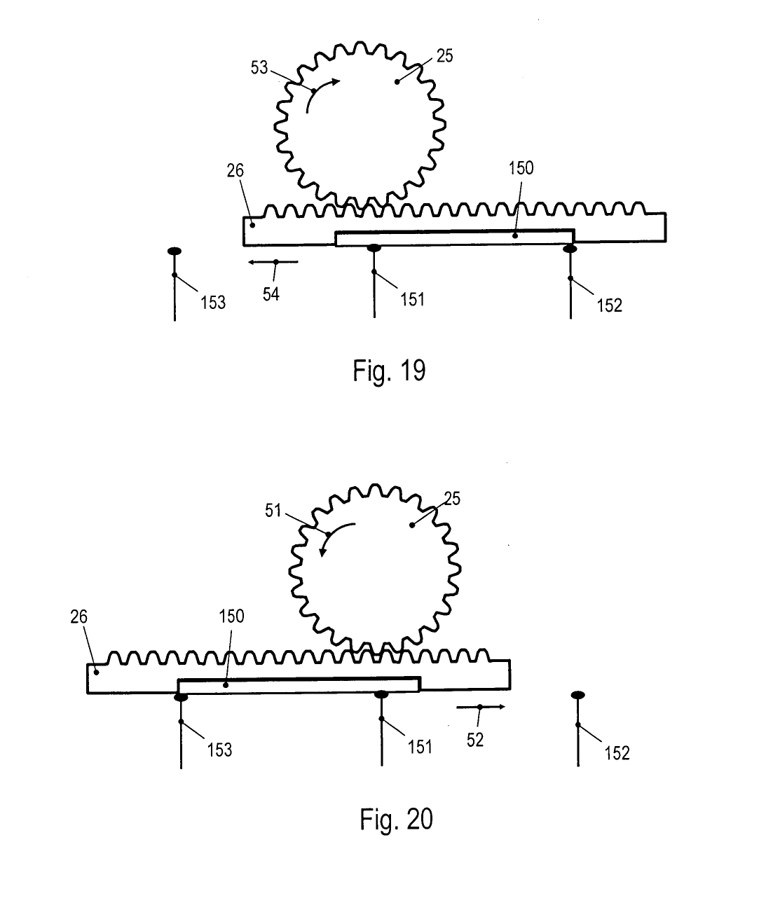

FIGS. 19 and 20 illustrate components of an actuator arrangement according to yet another embodiment during different stages of an operation cycle. Components which correspond to components explained with reference to one of FIGS. 1-12 are designated with the same reference numerals. The actuator arrangement may include any one of the other components explained with reference to FIGS. 1-12, in particular a power drive to drive the pinion 25.

The actuator arrangement uses two single pole double throw (SPDT) switches. The two SPDT switches include conductors 151-153 which respectively have an end which may be brought into electrical contact with an electrically conductive section 150 of the rack 26. The ends of the conductors 151-153 may be formed as brushes. Depending on the position of the rack 26, the conductive section 150 selectively establishes an electrical contact between terminals 151 and 152. Similarly, depending on the position of the rack 26, the conductive section 150 selectively establishes an electrical contact between terminals 151 and 153. Thereby, a SPDT switch with terminals 151 and 152 and another SPDT switch with terminals 151 and 153 may be closed or opened as a function of rack position.

The two SPDT switches are electrically coupled to an H-bridge, relay or other electrically switchable element. When one of the two SPDT switches is closed, the polarity of the bias applied at the power supply terminals of the power drive is reversed. To this end, the polarity of the H-bridge may be reversed or a DPDT relay may be toggled.

As illustrated in FIGS. 19 and 20, the rack 26 causes one of the SPDT switches to be closed when the rack 26 is at the reversal points of the massage movement. The SPDT switches do not mechanically block movement of the rack 26 beyond these points. This allows the rack 26 to be driven beyond the massage mode reversal points when the manual mode is activated.

In yet other embodiments, interaction between the actuating member and an electrically operable switch or electronically operable switch, such as a relay or H-bridge, may be established in still other ways. For illustration, two electromagnetic sensors may be arranged to be spaced along the movement direction of the rack 26. The sensors may be configured as Hall sensors which sense a magnetic material.

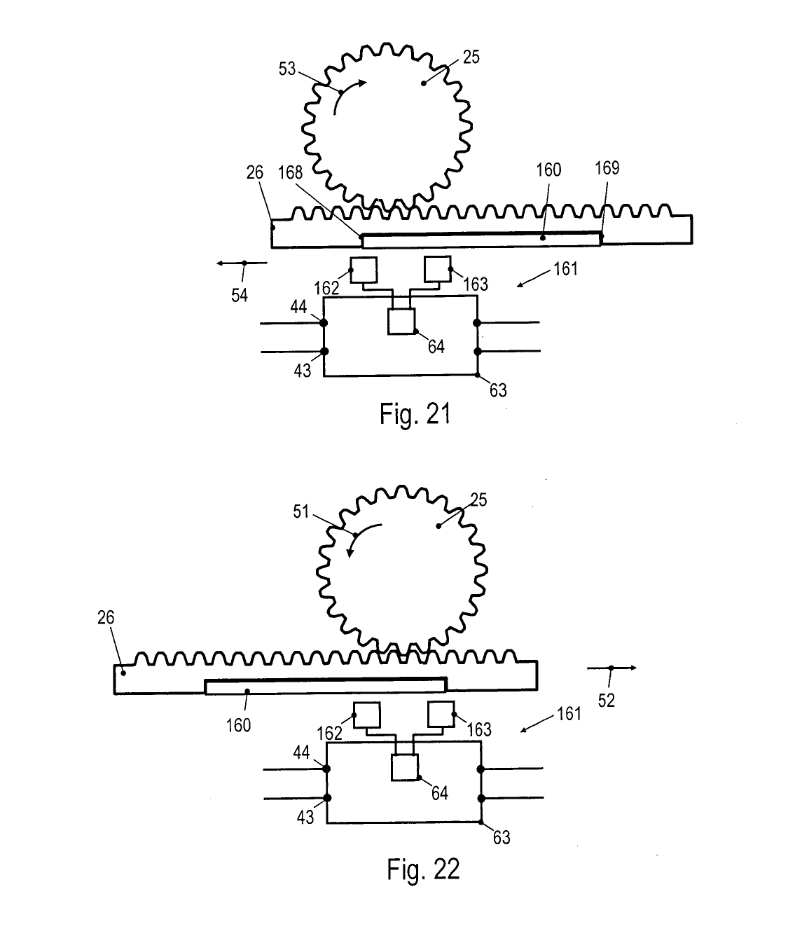

FIGS. 21 and 22 illustrate components of an actuator arrangement according to yet another embodiment during different stages of an operation cycle. Components which correspond to components explained with reference to one of FIGS. 1-12 are designated with the same reference numerals. The actuator arrangement may include any one of the other components explained with reference to FIGS. 1-12, in particular a power drive to drive the pinion 25.

In the actuator arrangement, magnetic material 160 is provided on the rack 26. The magnetic material 160 may be formed as a magnetic strip. The magnetic strip may extend along the longitudinal axis of the rack 26.

A switch means 161 includes an electrically or electronically operable switch 64. The electrically or electronically operable switch 64 may be a relay, an H-bridge or another electrically or electronically operable switch. The switch means 161 includes two electromagnetic sensors 162 and 163. The electromagnetic sensors 162 and 163 may be formed as Hall effect (HE) sensors. The electromagnetic sensors 162 and 163 are arranged so as to be spaced along a movement direction of the rack 26. The distance between the electromagnetic sensors 162 and 163 may be selected based on a desired amplitude of the reciprocating movement of the rack 26 in massage mode.

The electrically or electronically operable switch 64 is toggled based on output signals of the sensors 162 and 163. The rack 26 with the magnetic strip 160 causes the output signal of one of the sensors 162 or 163 to change when it is in one of the reversal points of the massage movement. End 168 and 169 of the magnetic strip 160 interact with the switch means 161 in a contact-free manner.

FIG. 21 shows the rack 26 positioned at a reversal point. When the rack 26 has reached this reversal position, the first sensor 162 senses that an end 168 of the magnetic strip 160 has reached the first sensor 162. The output signal of the first sensor 162 will change from one value (which may be represented as a logical “1”) which indicates that there is magnetic material positioned in front of the first sensor 162 to another value (which may be represented as a logical “0”) which indicates that there end 168 of the magnetic strip 160 has reached the first sensor 162. This change in output signal, effected by the rack 26, causes the electrically or electronically operable switch 64 to toggle. A polarity of the bias at the power supply terminals of the power drive is reversed, causing the pinion 25 to rotate in a second direction of rotation 53. The rack 26 is linearly displaced in a second movement direction 54.

The electrically or electronically operable switch 64 is not toggled again while both sensors 162 and 163 sense proximity of a magnetic material. I.e., the switch 64 remains in the last state while the output signals of both sensors 162 and 163 indicate that the magnetic strip 160 is positioned in proximity to the respective sensor. Toggling occurs again only when the output signal of the second sensor 163 indicates that the other end 169 of the magnetic strip is positioned at the second sensor 163.

FIG. 22 shows the rack 26 positioned at another reversal point. When the rack 26 has reached this reversal position, the second sensor 163 senses that another end 169 of the magnetic strip 160 has reached the second sensor 163. The output signal of the second sensor 163 will change from one value (which may be represented as a logical “1”) which indicates that there is magnetic material positioned in front of the second sensor 163 to another value (which may be represented as a logical “0”) which indicates that the other end 169 of the magnetic strip 160 has reached the second sensor 163. This change in output signal, effected by the rack 26, causes the electrically or electronically operable switch 64 to toggle. Bias at the power supply terminals of the power drive is reversed again, causing the pinion 25 to rotate in a first direction of rotation 51. The rack 26 is linearly displaced in a second movement direction 52.

As illustrated in FIGS. 21 and 22, the rack 26 causes the switch means 161 to toggle when the rack 26 is at the reversal points of the massage movement. The switch means 161 does not mechanically block movement of the rack 26 beyond these points. This allows the rack 26 to be driven beyond the massage mode reversal points when the manual mode is activated.

The sensors 162 and 163 are contact-free sensors. This allows wear problems to be mitigated. Ends 168, 169 of the magnetic strip 160 act as toggle structures which interact with the switch means 161 in a contact-free manner and cause the switch means 161 to toggle.

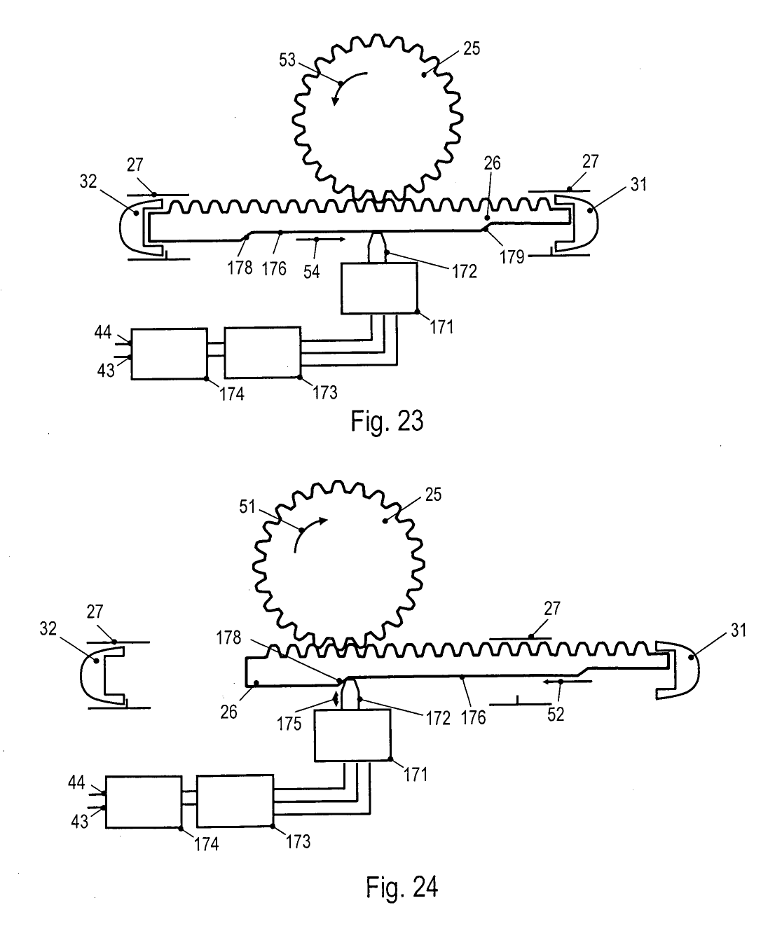

In yet other embodiments, the switch means may include a switch which has three different states or more than three different states. For illustration, in the various embodiments which use a switch mechanically coupled to an adjusting member, a switch having three different states may be used. The adjusting member may have a structured surface interacting with the switch. An embodiment having such a configuration will be described in detail with reference to FIGS. 23 and 24.

FIGS. 23 and 24 illustrate components of an actuator arrangement according to yet another embodiment during different stages of an operation cycle. Components which correspond to components explained with reference to one of FIGS. 1-12 are designated with the same reference numerals. The actuator arrangement may include any one of the other components explained with reference to FIGS. 1-12, in particular a power drive to drive the pinion 25.

In the actuator arrangement, a rack 26 has a structured surface 176 which interacts with a switch means. Two inclined regions 178, 179 angled relative to a longitudinal axis of the rack 26 are provided on the surface 176 of the rack 26. The structured surface 176 is engaged with a displaceable element 172 of the switch means.

The switch means includes a first switch 171 and an electrically or electronically operable switch 174 coupled to the first switch 171. The electrically or electronically operable switch 174 may be a relay, an H-bridge or another electrically or electronically operable switch. The first switch 171 includes a displaceable element 172, which is displaceable towards and away from the surface 176 of the rack 26. The first switch 171 may be configured such that the displaceable element 172 is biased towards the surface 176 of the rack 26.

The surface 176 has at least three different areas. A first area extends from the inclined region 178 to an end of the rack 26. A second area extends between the inclined regions 178, 179. A third area extends from the inclined region 179 to the other end of the rack 26. When the displaceable element 172 abuts on one of the inclined regions 178 or 179, it is depressed further into the first switch 171 or is allowed to protrude by a greater distance from the first switch 171. Depending on whether the displaceable element 172 is positioned at the first area, the second area or the third area of the surface 176, the first switch 171 is in one of three different states. The three different states of the first switch 171 may correspond to three different distances by which the displaceable element 172 protrudes from the first switch 171.

The first switch 171 is coupled to the electrically or electronically operable switch 174. When the surface 176 of the rack 26 causes the displaceable element 172 to be displaced into or out of the first switch 171, the electrically or electronically operable switch 174 may be caused to toggle between its two states.

FIG. 24 shows the rack 26 positioned at a reversal position. When the rack 26 has reached this reversal position, the inclined region 178 displaces the displaceable element 172. The change in state of the first switch 171, effected by the rack 26, causes the electrically or electronically operable switch 174 to toggle. A polarity of the bias at the power supply terminals of the power drive may be reversed, causing the pinion 25 to rotate in a first direction of rotation 51. The rack 26 is then linearly displaced in a first movement direction 52.

With an actuator arrangement as illustrated in FIGS. 23 and 24, the rack 26 is not mechanically blocked from moving beyond the positions at which one of the inclined regions 178 or 179 causes the displaceable element 172 to be displaced, thereby toggling the switch means. In a manual operation mode, the rack 26 may be driven beyond these positions.

Further, the switch means may include an adjustable control element 173 which allows a massage amplitude to be adjusted. The adjustable control element 173 is optional and may be omitted in other embodiments. The adjustable control element 173 may be added to the switch means based on whether an adjustment of a massage amplitude is desired. The adjustable control element 173 may be configured as a delay circuit having an adjustable delay. Other configurations may be used. For illustration, the adjustable control element 173 may be or may include a simple logic circuit. When the state of the first switch means 171 changes, the adjustable control element 173 may provide a corresponding signal to the electrically or electronically operable switch 174 with a delay, the magnitude of the delay being adjustable.

This configuration allows the rack 26 to be driven to positions at which the displaceable element 172 has moved beyond one of the inclined regions 178, 179 when the massage mode is activated. For illustration, the control element 173 may provide a signal indicative of the change in state of the first switch 171 to the electrically or electronically operable switch 174 at a time delay which is 0.5 seconds, 1 second, or 2 seconds, or another time delay selected from a range of available time delays. This causes the pinion 25 to continue rotation in a given direction even when the displaceable element 172 has already slid beyond the associated inclined region 178 or 179. As indicated above, the rack 26 is not mechanically blocked against such a movement. By adjusting the time delay of the adjustable control element 173, the distance by which the rack 26 is driven beyond the position at which the displaceable element 172 abuts on the inclined regions 178, 179 may be adjusted. This allows an amplitude of the massage movement to be adjusted.

While switch means interacting with an adjusting member that is configured as a rack are illustrated in FIGS. 13-24, such switch means may be used also in combination with other adjusting linkages and adjusting members. For illustration, the switch means explained with reference to any one of FIGS. 13-24 may also be used in combination with a spindle drive.

While embodiments have been described with reference to the drawings, various modifications may be implemented in further embodiments. For illustration, adjusting linkages having alternative configurations may be used. Adjusting linkages may include rigid members which are displaceably or pivotably supported.

While some embodiments have been described in the context of shifting an apex position of a lumbar support, actuator arrangements according to embodiments may also be used for other purposes. For illustration, the curvature of an arching member may be periodically changed using an actuator arrangement of an embodiment.

While some embodiments have been described in which the switch means is arranged at a fixed location relative to the power drive, the switch means may also be displaceably arranged. For illustration, the switch means, or at least the sensor of the switch means, having any one of the various configurations described herein may be attached to the adjusting member so as to move jointly with the adjusting member. Fixed structures for toggling the switch means may be provided such that the switch means interacts with one of the fixed structures when the adjusting member is in a first pre-determined position and when the adjusting member is in a second pre-determined position.

While some embodiments have been described in the context of adjusting a lumbar support, the actuator arrangements and methods according to embodiments may also be used for adjusting other support structures for seats or other adjustable seat components. For illustration, massage components installed in a seat section of a seat may be operated using an actuator arrangement according to an embodiment, in order to stimulate blood circulation in an occupant's legs.

Exemplary embodiments of the invention may be utilized in a wide variety of seats, in particular in vehicle seats for motor vehicle seating, without being limited thereto.

1-15. (canceled)

16. An actuator arrangement for a seat having an adjustable component, the actuator arrangement comprising:
an adjusting linkage coupled to the adjustable component;
a power drive having terminals, the power drive coupled to an adjusting member of the adjusting linkage and configured to effect a relative displacement between the adjusting member and the power drive, the power drive configured to rotate in a first direction of rotation when a first voltage is applied at the terminals and to rotate in a second direction of rotation opposite to the first direction of rotation when a second voltage is applied at the terminals; and
a switch means coupled to the terminals, the switch means configured to set a voltage applied at the terminals to the first voltage when the switch means is in a first state and to the second voltage when the switch means is in a second state different from the first state,
wherein the adjusting member and the switch means are configured such that the adjusting member causes the switch means to toggle between the first state and the second state.

17. The actuator arrangement of claim 16, wherein the adjusting member and the switch means are configured such that the adjusting member causes the switch means to toggle from the first state to the second state when the adjusting member is in a first pre-determined position relative to the power drive, and such that the adjusting member causes the switch means to toggle from the second state to the first state when the adjusting member is in a second pre-determined position different from the first pre-determined position relative to the power drive.

18. The actuator arrangement of claim 17, wherein the adjusting member comprises a first toggle structure and a second toggle structure spaced from the first toggle structure, and wherein the first toggle structure and the second toggle structure are configured such that the first toggle structure interacts with the switch means when the adjusting member is in the first pre-determined position, and such that the second toggle structure interacts with the switch means when the adjusting member is in the second pre-determined position.

19. The actuator arrangement of claim 18, wherein the first toggle structure is formed on a surface of the adjusting member and the second toggle structure is formed on the surface of the adjusting member.

20. The actuator arrangement of claim 18, wherein the switch means includes a displaceable element, and wherein the first toggle structure and the second toggle structure are configured for engagement with the displaceable element.

21. The actuator arrangement of claim 18, wherein the switch means comprises a contact-free sensor configured to sense the first toggle structure and the second toggle structure.

22. The actuator arrangement of claim 21, wherein the switch means comprises an electrically operated switch or an electronically operated switch coupled to the sensor.

23. The actuator arrangement of claim 16, wherein the adjusting linkage includes at least one flexible traction member configured to couple the adjusting member to the adjustable component.

24. The actuator arrangement of claim 23, wherein the at least one flexible traction member includes a first flexible traction member and a second flexible traction member, and wherein the first flexible traction member is coupled to a first end of the adjusting member and the second flexible traction member is coupled to a second end of the adjusting member opposite to the first end.

25. The actuator arrangement of claim 16, wherein the adjusting member has a structured exterior surface engaged with a transmission interconnected between the power drive and the adjusting member.

26. The actuator arrangement of claim 16, further comprising: a selection switch having a plurality of states and configured to supply power to the power drive via the switch means only if the selection switch is in a pre-determined state of the plurality of states.

27. A seat comprising:
an adjustable component; and
an actuator arrangement including
an adjusting linkage coupled to the adjustable component;
a power drive having terminals, the power drive coupled to an adjusting member of the adjusting linkage and configured to effect a relative displacement between the adjusting member and the power drive, the power drive configured to rotate in a first direction of rotation when a first voltage is applied at the terminals and to rotate in a second direction of rotation opposite to the first direction of rotation when a second voltage is applied at the terminals; and
a switch means coupled to the terminals, the switch means configured to set a voltage applied at the terminals to the first voltage when the switch means is in a first state and to the second voltage when the switch means is in a second state different from the first state,
wherein the adjusting member and the switch means are configured such that the adjusting member causes the switch means to toggle between the first state and the second state.

28. The seat of claim 27, wherein the adjustable component includes a first arching section and a second arching section mounted in the seat so as to be offset relative to each other, and wherein the adjusting linkage of the actuator arrangement is configured to adjust a curvature of the first arching section and a curvature of the second arching section.

29. The seat of claim 27, wherein the adjustable component includes a member mounted to be displaceable along a guide installed in the seat, wherein the power drive is mounted to the member, and further wherein the adjusting linkage of the actuator arrangement is coupled to the member and is configured to displace the member along the guide.

30. A method of adjusting an adjustable component of a seat, the method comprising:
cyclically adjusting the adjustable component by an actuator arrangement, the actuator arrangement including
an adjusting linkage coupled to the adjustable component;
a power drive having terminals, the power drive coupled to an adjusting member of the adjusting linkage and configured to effect a relative displacement between the adjusting member and the power drive, the power drive configured to rotate in a first direction of rotation when a first voltage is applied at the terminals and to rotate in a second direction of rotation opposite to the first direction of rotation when a second voltage is applied at the terminals; and
a switch means coupled to said terminals, the switch means configured to set a voltage applied at the terminals to the first voltage when the switch means is in a first state and to the second voltage when the switch means is in a second state different from the first state,
wherein the adjusting member and the switch means are configured such that the adjusting member causes the switch means to toggle between the first state and the second state.

33.-34. (canceled)
